(19) United States
(12) Patent Application Publication
(10) Pub. No.: US 2024/0421674 A1
(43) Pub. Date: Dec. 19, 2024

(54) METHOD FOR MANUFACTURING LAMINATED IRON CORE

(71) Applicant: TOYOTA BOSHOKU KABUSHIKI KAISHA, Aichi-ken (JP)

(72) Inventor: Yoshinori ISHIKAWA, Anjo-shi (JP)

(73) Assignee: TOYOTA BOSHOKU KABUSHIKI KAISHA, Aichi-ken (JP)

(21) Appl. No.: 18/737,228

(22) Filed: Jun. 7, 2024

(30) Foreign Application Priority Data
Jun. 16, 2023 (JP) 2023-099296

(51) Int. Cl. H02K 15/03; H02K 1/276; H02K 1/32

(52) U.S. Cl. CPC H02K 15/03; H02K 1/276; H02K 1/32

(57) ABSTRACT

A method for manufacturing a laminated iron core includes sequentially performing multiple types of machining on designated portions of a workpiece from which iron core pieces are to be punched out, determining whether standard machining has been performed on each designated portion, forming core piece blocks by stacking the iron core pieces to have a specified stacking height, and forming, when it is determined that the standard machining has not been performed on any of the designated portions through the determining whether standard machining has been performed, a dummy block by stacking the iron core pieces that include the iron core piece formed by punching out the designated portion not having been subjected to the standard machining, the formed dummy block having a stacking height different from the specified stacking height.

### CROSS-REFERENCE TO RELATED APPLICATIONS

This application is based upon and claims the benefit of priority from prior Japanese Patent Application No. 2023-099296, filed on Jun. 16, 2023, the entire contents of which are incorporated herein by reference.

### BACKGROUND

### 1. Field

The present disclosure relates to a method for manufacturing a laminated iron core.

### 2. Description of Related Art

A laminated iron core used in a rotating electric machine is formed by stacking iron core pieces that are punched out from a plate-shaped workpiece, which is conveyed intermittently. The laminated iron core includes through-holes formed in the iron core pieces. The through-holes are connected to each other so that recesses and holes are formed.

Japanese Laid-Open Patent Publication No. 2014-176235 discloses a rotor core that includes cooling passages through which cooling medium flows. The cooling passages are formed by connecting through-holes that are formed in the iron core pieces and have different shapes together. These through-holes are formed, for example, by selectively switching the state of multiple types of punches arranged in the conveying direction of a workpiece between a state in which the punches can punch out the through-holes and a state in which the punches cannot punch the through-holes.

When the state of the multiple types of punches is not switched properly, machining may not be performed on portions of each iron core piece that should be machined, or machining may be performed on portions of each iron core pieces that should not be machined. In such a case, the shape of the laminated iron core differs from the desired shape. Therefore, it is desirable to prevent the laminated iron core from including any iron core piece having a shape different from the desired shape.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for manufacturing a laminated iron core that includes multiple stacked core piece blocks is provided. Each core piece block includes stacked iron core pieces that are punched out from a plate-shaped workpiece that is intermittently conveyed. The method comprising sequentially performing multiple types of machining on designated portions of the workpiece from which the iron core pieces are to be punched out, determining whether standard machining has been performed on each designated portion, forming each core piece block by stacking the iron core pieces to have a specified stacking height, and forming, when it is determined that the standard machining has not been performed on any of the designated portions through the determining whether standard machining has been performed, a dummy block by stacking the iron core pieces that include the iron core piece formed by punching out the designated portion not having been subjected to the standard machining, the formed dummy block having a stacking height different from the specified stacking height.

Other features and aspects will be apparent from the following detailed description, the drawings, and the claims.

### BRIEF DESCRIPTION OF THE DRAWINGS

FIG. 1 is a plan view showing a rotating electric machine including laminated iron cores according to one embodiment.

FIG. 2 is a cross-sectional view of the rotor shown in FIG. 1.

FIG. 3 is a cross-sectional view showing a core piece block that forms the rotor core and the stator core shown in FIG. 1.

FIG. 4 is a plan view showing a core piece block that forms a first passage shown in FIG. 2.

FIG. 5 is a plan view showing a core piece block that forms a first passage and an inner passage shown in FIG. 2.

FIG. 6 is a plan view showing a core piece block that forms a first passage and an outer passage shown in FIG. 2.

FIG. 7 is a schematic diagram showing the configuration of an apparatus for manufacturing the laminated iron core according to the embodiment.

FIG. 8 is a cross-sectional view showing the structure of a rotor press device shown in FIG. 7.

FIG. 9 is a plan view showing a workpiece of which the thickness is measured by a thickness measuring device shown in FIG. 7.

FIG. 10 is a plan view showing core piece blocks conveyed by a conveying mechanism.

FIG. 11A is a plan view showing core piece blocks sorted by a sorting member.

FIG. 11B is a plan view showing dummy blocks that pass through the sorting member.

FIG. 12 is a side view showing a core piece block and dummy blocks that are sorted by the sorting member.

FIG. 13 is a plan view showing a state in which the thickness measuring device shown in FIG. 7 faces the downstream end of a designated portion.

FIG. 14 is a plan view showing a state in which the thickness measuring device shown in FIG. 7 faces the upstream end of a designated portion.

FIG. 15 is a cross-sectional view showing core piece blocks of which the numbers of the stacked core pieces are adjusted.

FIG. 16 is a flowchart showing a procedure of an anomaly determining process.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

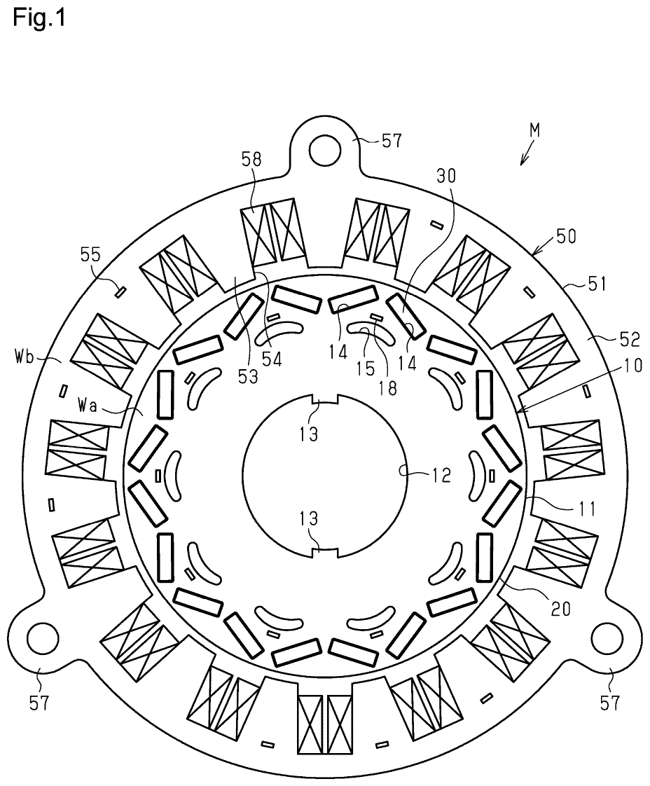

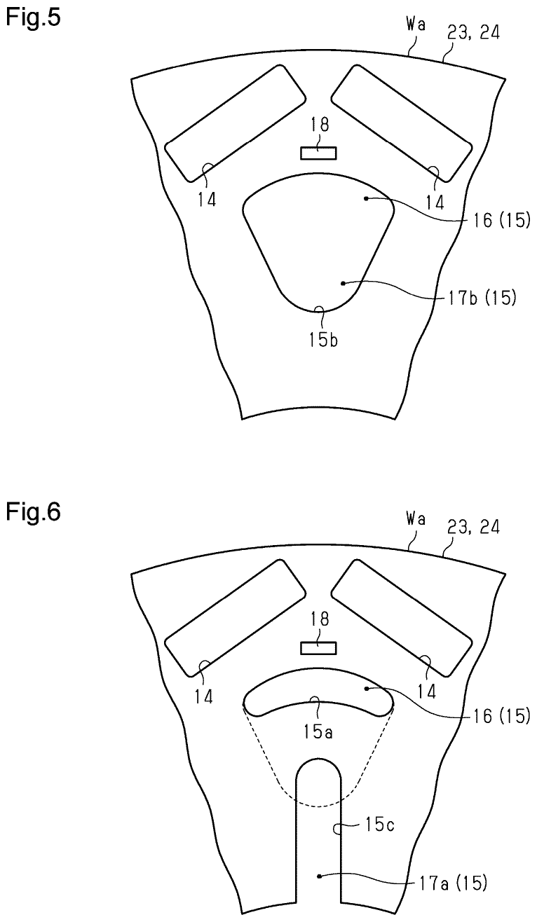

One embodiment will now be described with reference to FIGS. 1 to 16.

As shown in FIG. 1, a rotating electric machine M includes a rotor 10 and a stator 50. The rotor 10 and the stator 50 are each cylindrical. The stator 50 is fixed to a housing (not shown). The rotor 10 is configured to be rotatable inside the stator 50.

### Rotor 10

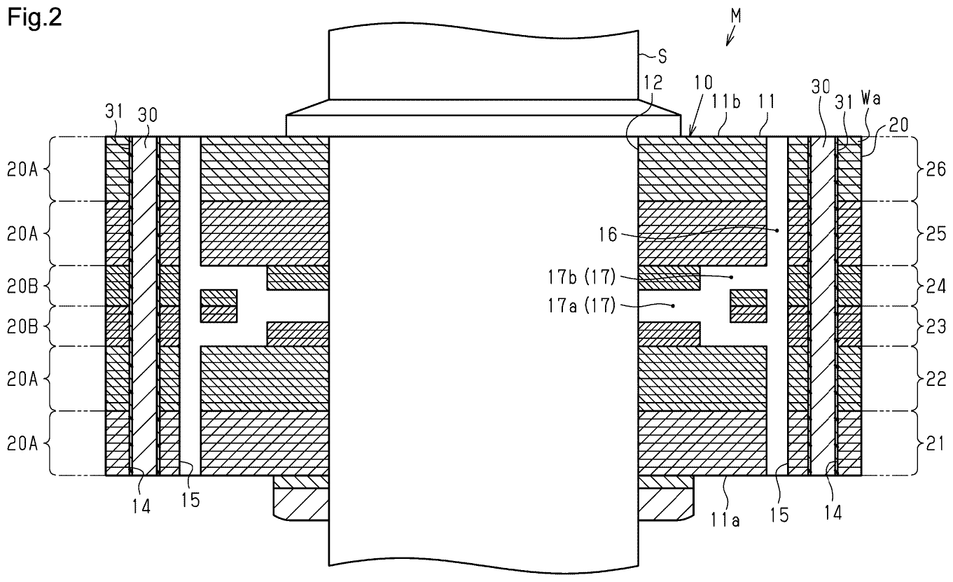

As shown in FIG. 2, the rotor 10 includes a rotor core 11, magnets 30, and plastic members 31. The rotor 10 is, for example, a magnet-embedded rotor.

The rotor core 11 is substantially cylindrical. The rotor core 11 is formed by stacking annular rotor core pieces Wa, which are punched out from a magnetic steel sheet. The rotor core 11 is an example of a laminated iron core.

In the following description, the direction in which the rotor core pieces Wa in the rotor core 11 are stacked will simply be referred to as a stacking direction. The radial direction of the rotor core 11 will simply be referred to as a radial direction. The circumferential direction of the rotor core 11 will simply be referred to as a circumferential direction.

The rotor core 11 includes a center hole 12, into which a shaft S is inserted, magnet housing holes 14, which accommodate magnets 30, and cooling passages 15, through which cooling medium such as oil flows. The center hole 12, the magnet housing holes 14, and the cooling passages 15 extend through the rotor core 11 in the stacking direction. That is, the center hole 12, the magnet housing holes 14, and the cooling passages 15 open in a lower surface 11a, which is one end face in the stacking direction of the rotor core 11, and in an upper surface 11b, which is another end face.

As shown in FIG. 1, the center hole 12 is substantially circular. Two protruding keys 13, which are opposed to each other in the radial direction, are provided on the inner surface of the center hole 12. The keys 13 are fitted into two keyways (not shown) provided in the shaft S to restrict relative movement between the rotor core 11 and the shaft S in the circumferential direction.

The magnet housing holes 14 are located on the outer side in the radial direction of the center hole 12 and spaced apart from each other in the circumferential direction. The rotor core 11 includes, for example, twenty magnet housing holes 14. The openings of the magnet housing holes 14 are, for example, substantially rectangular in plan view. The two in each circumferentially adjacent pair of the magnet housing holes 14 are inclined in opposite directions with respect to the circumferential direction.

The cooling passages 15 are located radially inward of the magnet housing holes 14 and arranged at equal intervals in the circumferential direction. The rotor core 11 includes, for example, ten cooling passages 15.

As shown in FIG. 2, the cooling passages 15 include first passages 16, which extend in the stacking direction, and second passages 17, which extend in the radial direction.

The first passages 16 open in the lower surface 11a and the upper surface 11b of the rotor core 11.

The second passages 17 open in the first passages 16 and in the inner circumferential surface of the center hole 12. In other words, the second passages 17 connect the first passages 16 and the center hole 12 to each other.

The second passages 17 each include an inner passage 17a and two outer passages 17b.

The inner passages 17a are located at the center in the stacking direction of the rotor core 11 and extend in the radial direction. Each inner passage 17a opens in the inner circumferential surface of the center hole 12 and is connected to a connecting hole (not shown) formed in the outer circumferential surface of the shaft S.

The outer passages 17b branch from the radially outer end of each inner passage 17a and extend in the radial direction. The outer passages 17b open in the corresponding first passage 16. Thus, the outer passages 17b open at two positions of the first passage 16 that are spaced apart from each other in the stacking direction.

The rotor core 11 is formed by a laminated body in which the rotor core pieces Wa are stacked. The laminated body includes one or more core piece blocks 20, which is formed by stacking rotor core pieces Wa. The rotor core 11 of the present embodiment is formed by stacking six core piece blocks 20. Metal end plates may be welded to the lower surface 11a and the upper surface 11b of the rotor core 11 to prevent the magnets 30 from projecting from the magnet housing holes 14.

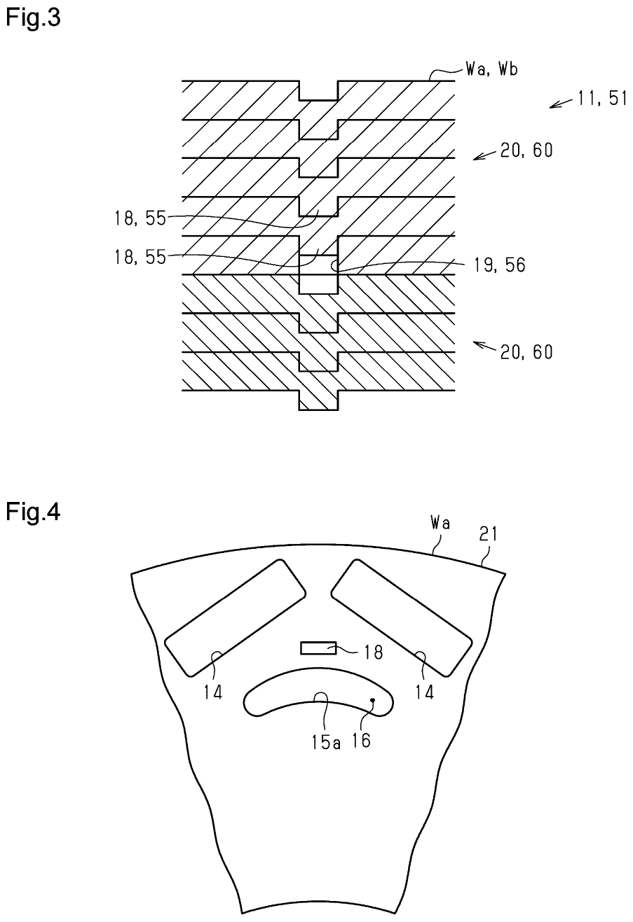

As shown in FIG. 3, the rotor core pieces Wa each includes tabs 18, which bulge toward one side in the thickness direction. The tabs 18 are arranged at intervals in the circumferential direction in each rotor core piece Wa. The tabs 18 protrude from the upper surface 11b toward the lower surface 11a of the rotor core 11.

In each core piece block 20, adjacent ones of the rotor core pieces Wa are coupled to each other by press-fitting the tabs 18 to each other. In each core piece block 20, the rotor core piece Wa forming one end in the stacking direction includes press-fit holes 19 extending through the rotor core piece Wa in the stacking direction. One of the rotor core pieces Wa including the tabs 18 and the rotor core piece Wa including the press-fit holes 19 are coupled to each other by fitting the tabs 18 into the press-fit holes 19. In this manner, the rotor core pieces Wa of each core piece block 20 are integrated by being coupled to each other.

The rotor core piece Wa including the press-fit holes 19 of each core piece block 20 is not coupled to a rotor core piece Wa of the core piece block 20 adjacent to the core piece block 20 that includes the rotor core piece Wa including the press-fit holes 19.

As shown in FIG. 1, the tabs 18 and the press-fit holes 19 are arranged radially outward of the cooling passages 15 and between two of the magnet housing holes 14 that are adjacent to each other in the circumferential direction.

As shown in FIG. 2, the rotor core 11 includes six core piece blocks 20 that are formed by stacking rotor core pieces Wa punched out from a single magnetic steel sheet. The core piece blocks 20 do not include any rotor core pieces Wa that are punched out from different magnetic steel sheets. This reduces the variation in the thickness of the core piece blocks 20, that is, the lamination thickness of the rotor core 11.

In the following description, the first to sixth core piece blocks 20 counted from the lower surface 11a of the rotor core 11 are referred to as a first block 21, a second block 22, a third block 23, a fourth block 24, a fifth block 25, and a sixth block 26, respectively.

The first block 21 forms the lower surface 11a of the rotor core 11. The sixth block 26 forms the upper surface 11b of the rotor core 11.

The lamination thicknesses of the first block 21, the second block 22, the fifth block 25, and the sixth block 26 are substantially the same. The lamination thicknesses of the third block 23 and the fourth block 24 are substantially the same and less than the lamination thicknesses of the other core piece blocks 20.

The first passages 16 and the second passages 17 are formed by connecting through-holes 15a to 15c (refer to FIGS. 4 to 6), which are formed in the rotor core pieces Wa of each of the blocks 21 to 26 and have different shapes.

As shown in FIG. 4, the first block 21, the second block 22, the fifth block 25, and the sixth block 26 are formed by stacking rotor core pieces Wa having through-holes 15a. The through-holes 15a form the first passages 16. The first block 21, the second block 22, the fifth block 25, and the sixth block 26 form only the first passages 16 in the cooling passages 15.

As shown in FIGS. 2, 5, and 6, the third block 23 and the fourth block 24 are formed by stacking rotor core pieces Wa having through-holes 15b and rotor core pieces Wa having through-holes 15a and a through-holes 15c. The through-holes 15b form the first passages 16 and the outer passages 17b of the second passages 17. The through-holes 15c form the inner passages 17a of the second passages 17. Thus, the third block 23 and the fourth block 24 form the first passages 16 and the second passages 17 of the cooling passages 15. Accordingly, the second passages 17 are formed only by the third block 23 and the fourth block 24.

In the following description, a core piece block 20 that forms only the first passages 16 of the cooling passages 15 may be referred to as a first passage block 20A. Also, a core piece block 20 that forms the first passage 16 and the second passages 17 of the cooling passages 15 may be referred to as a second passage block 20B. In the present embodiment, the first block 21, the second block 22, the fifth block 25, and the sixth block 26 correspond to the first passage blocks 20A. The third block 23 and the fourth block 24 correspond to the second passage blocks 20B.

As shown in FIG. 2, each magnet 30 has an elongated shape extending in the stacking direction. Each magnet 30 has a substantially rectangular cross section orthogonal to the stacking direction.

The length of each magnet 30 in the stacking direction may be equal to or shorter than the length of each magnet housing hole 14. Each magnet housing hole 14 may accommodate one magnet 30 or two or more magnets 30.

The magnets 30 are, for example, permanent magnets.

The plastic members 31 are obtained by hardening plastic filling the magnet housing holes 14, which accommodate the magnets 30. The magnets 30 are fixed to the rotor core 11 by the plastic members 31. The core piece blocks 20 are fixed to each other by the plastic members 31. Each plastic member 31 may cover, for example, opposite end faces in the stacking direction of the corresponding magnet 30.

The plastic members 31 are, for example, made of a thermosetting plastic such as an epoxy plastic.

### Stator 50

As shown in FIG. 1, the stator 50 includes a stator core 51 and coils 58.

As in the case of the rotor core 11, the stator core 51 is formed by stacking stator core pieces Wb, which are punched out from a magnetic steel sheet. The stator core 51 is another example of a laminated iron core.

The stator core 51 includes a yoke 52, teeth 53, and slots 54. The yoke 52 is cylindrical. The teeth 53 project radially inward from the yoke 52 and are spaced apart from each other in the circumferential direction. The slots 54 are each formed between two of the teeth 53 that are adjacent to each other in the circumferential direction.

The stator core 51 includes three fixing portions 57 that protrude outward in the radial direction from the yoke 52. The stator core 51 is fixed to a housing (not shown) by fastening the three fixing portions 57 to the housing with bolts (not shown).

The coils 58 include, for example, three phase windings forming a U-phase, a V-phase, and a W-phase. Each phase winding is wound about two or more of the teeth 53.

As shown in FIG. 3, the stator core 51 is formed by stacking core piece blocks 60 formed by stacking multiple stator core pieces Wb.

The stator core pieces Wb each includes tabs 55, which bulge toward one side in the thickness direction. The tabs 55 are arranged at intervals in the circumferential direction of each stator core piece Wb.

In the same manner as the core piece blocks 20 of the rotor core 11, the core piece blocks 60 are each formed by stacking stator core pieces Wb that include tabs 55, and a stator core piece Wb that includes press-fit holes 56.

### Apparatus for Manufacturing Laminated Iron Core

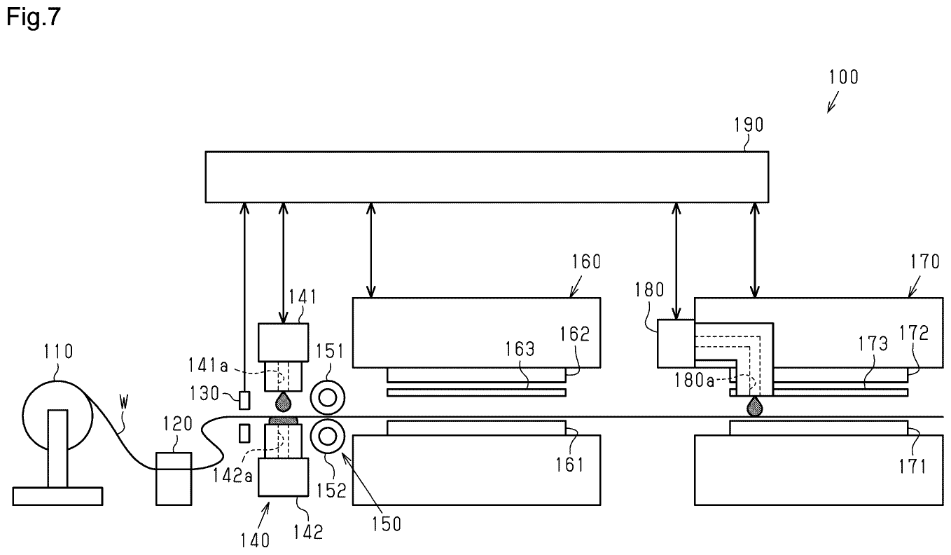

An apparatus for manufacturing the rotor core 11 and the stator core 51 (hereinafter, referred to as a manufacturing apparatus 100), which is an apparatus for manufacturing a laminated iron core, will now be described with reference to FIGS. 7 to 12.

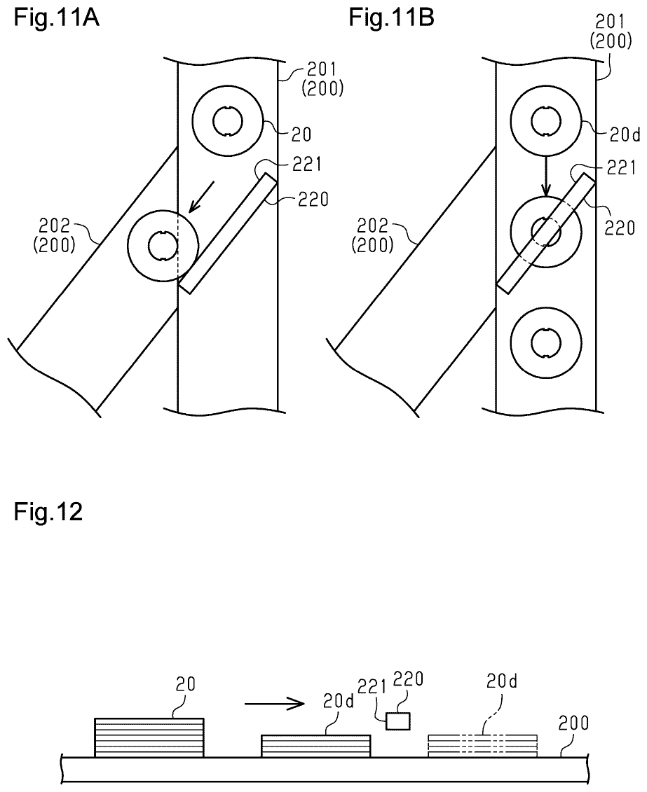

As shown in FIG. 7, the manufacturing apparatus 100 includes an uncoiler 110, a welding device 120, a thickness measuring device 130, a first oil supply device 140, an application roller assembly 150, a rotor press device 160, a stator press device 170, a second oil supply device 180, and a controller 190. The manufacturing apparatus 100 includes a conveying mechanism 200, a detecting unit 210, and a sorting member 220 (refer to FIGS. 10 to 11B).

The rotor press device 160 punches out rotor core pieces Wa from a workpiece W, which is made of a magnetic steel sheet, and stacks the rotor core pieces Wa to form core piece blocks 20.

The stator press device 170 punches out stator core pieces Wb from the workpiece W and stacks the stator core pieces Wb to form core piece blocks 60. The stator press device 170 is operated in synchronization with the rotor press device 160. The stator press device 170 is configured to punch out the stator core piece Wb from the workpiece W on a radially outer side of the portion from which the rotor core piece Wa has been punched out such that the stator core piece Wb is concentric with the portion from which rotor core piece Wa has been the punched out.

The controller 190 controls operation of, for example, the thickness measuring device 130, the first oil supply device 140, the rotor press device 160, the stator press device 170, and the second oil supply device 180.

The controller 190 controls operation of the rotor press device 160 and the stator press device 170 at specified shots per minute (SPM). The SPM refers to the number of times the workpiece W is punched per minute in the rotor press device 160 and the stator press device 170.

### Uncoiler 110

The uncoiler 110 rotationally supports the workpiece W wound in a rolled manner. The workpiece W drawn out of the uncoiler 110 is intermittently conveyed by a feed device (not shown) and supplied to the rotor press device 160 and the stator press device 170.

In the following description, the conveying direction of the workpiece W will simply be referred to as a conveying direction.

### Welding Device 120

The welding device 120 is disposed on the downstream side of the uncoiler 110 in the conveying direction.

The welding device 120 joins the end of a workpiece W that has been drawn from the uncoiler 110 to the leading end of a subsequent workpiece W supported by the uncoiler 110. The welding device 120 cuts an end portion of at least one of the two workpieces W and welds the end faces of the two workpieces W to each other. As a result, the two workpieces W are conveyed in an integrated state.

The thickness measuring device 130.

The thickness measuring device 130 is disposed on the downstream side of the welding device 120 in the conveying direction.

The thickness measuring device 130 is, for example, a noncontact sensor such as a laser displacement meter.

The thickness measuring device 130 constantly measures the thickness of the workpiece W. The thickness measuring device 130 obtains multiple measured values at a specified sampling cycle. The expression “the thickness measuring device 130 constantly measures the thickness of the workpiece W” means that a state in which the thickness measuring device 130 can obtain measured values continues.

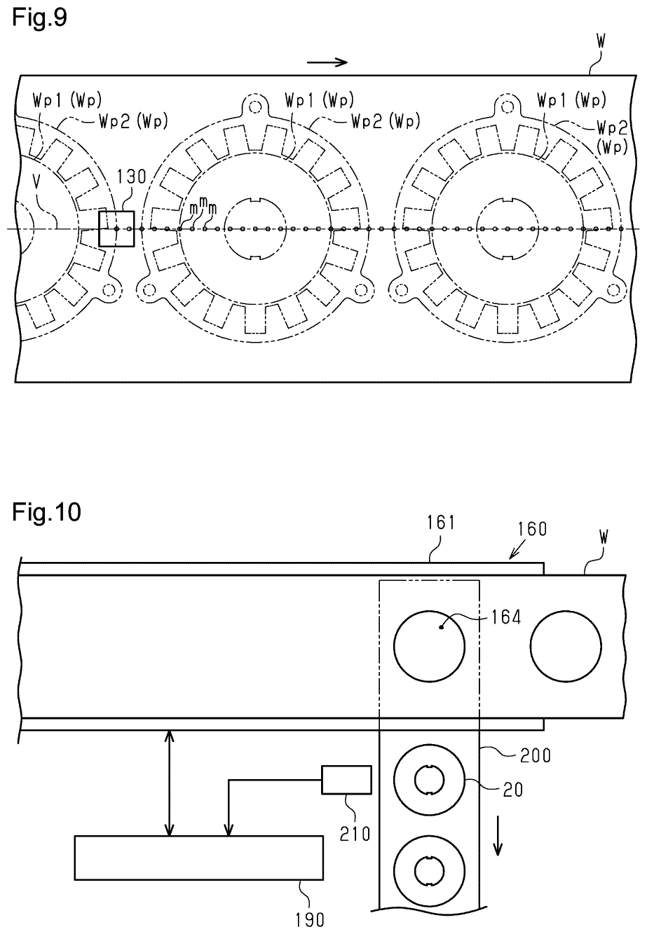

As shown in FIG. 9, as the workpiece W is conveyed, the thickness measuring device 130 measures both the thickness of each designated portion Wp of the workpiece W, from which a rotor core piece Wa and a stator core piece Wb are to be punched, and the thickness of a portion between designated portions Wp. The portion of the workpiece W between designated portions Wp is a portion that will be a scrap of the workpiece W, that is, a feed bridge.

Thickness measuring device 130 is disposed at a position where, each time movement of the workpiece W, which is intermittently conveyed, is stopped, the thickness measuring device 130 is sequentially faces the downstream end in the conveying direction of a designated portion Wp. The thickness measuring device 130 measures the thickness of each designated portion Wp at measurement points m that are arranged along an imaginary line V extending in the conveying direction and passing through the centers of the designated portions Wp.

Each designated portion Wp of the workpiece W includes a first designated portion Wp1, from which a rotor core piece Wa will be punched out, and a second designated portion Wp2, from which a stator core piece Wb will be punched out. The first designated portion Wp1 and the second designated portion Wp2 have a substantially circular outer shape as viewed in the thickness direction of the workpiece W. The second designated portion Wp2 is a portion of the workpiece W that is concentric with the first designated portion Wp1 on the radially outer side of the first designated portion Wp1. Thus, the thickness measuring device 130 measures the thicknesses of the first designated portion Wp1 and the second designated portion Wp2 at the measurement points m, which are arranged in the radial direction of the first designated portions Wp1 and the second designated portions Wp2.

### First Oil Supply Device 140

As shown in FIG. 7, the first oil supply device 140 is located on the downstream side of the thickness measuring device 130 in the conveying direction.

The first oil supply device 140 includes an upper supplying unit 141, which supplies machining oil to the upper surface of the workpiece W, and a lower supplying unit 142, which supplies machining oil to the lower surface of the workpiece W.

The upper supplying unit 141 includes multiple outlets 141a, which are arranged at intervals in the width direction of the workpiece W and discharge machining oil. The upper supplying unit 141 discharges machining oil from the outlets 141a through operation of an oil pump (not shown) controlled by the controller 190. The upper supplying unit 141, for example, intermittently drips machining oil from the outlets 141a to supply the machining oil to the upper surface of the workpiece W.

The lower supplying unit 142 has an outlet 142a that opens in an upper surface of the lower supplying unit 142 and discharges machining oil. The lower supplying unit 142 discharges machining oil from the outlet 142a through operation of an oil pump (not shown) controlled by the controller 190. The lower supplying unit 142 discharges machining oil from the outlet 142a, thereby forming an oil puddle of the machining oil on upper surface of the lower supplying unit 142. The lower supplying unit 142 forms the oil puddle at a position where the lower surface of the conveyed workpiece W passes through, thereby supplying the machining oil to the lower surface of the workpiece W.

The first oil supply device 140 is configured to increase or decrease the supply amount of machining oil per unit time in accordance with increase or decrease in the number of times the rotor core pieces Wa are punched out in the rotor press device 160 per unit time. The first oil supply device 140 is configured to increase or decrease the supply amount of machining oil per unit time in accordance with, for example, the increase or decrease in the SPM in the rotor press device 160.

The first oil supply device 140 increases or decreases the supply amount of machining oil based on commands from the controller 190. When controlling the operation of the rotor press device 160 at a specified SPM, the controller 190 controls the operation of the first oil supply device 140 to supply machining oil at a predetermined amount corresponding to that SPM.

### Application Roller Assembly 150

The application roller assembly 150 is disposed on the downstream side of the first oil supply device 140 in the conveying direction.

The application roller assembly 150 includes an upper roller 151, which slides on the upper surface of the workpiece W, and a lower roller 152, which slides on the lower surface of the workpiece W. The upper roller 151 and the lower roller 152 are located on opposite sides of the workpiece W. The upper roller 151 and the lower roller 152 are configured to rotate about rotation axes extending in the width direction of the workpiece W. The upper roller 151 and the lower roller 152 may be rotated by frictional force generated between the rollers 151, 152 and the workpiece W when the workpiece W is conveyed. Alternatively, the rollers 151, 152 may be rotated by a driving device.

The part of the workpiece W to which the machining oil supplied by the first oil supply device 140 has collected passes between the upper roller 151 and the lower roller 152, so that the machining oil is spread on the upper surface and the lower surface of the workpiece W. As a result, the machining oil supplied to the workpiece W is spread by the application roller assembly 150. No machining oil is supplied to the application roller assembly 150.

### Rotor Press Device 160

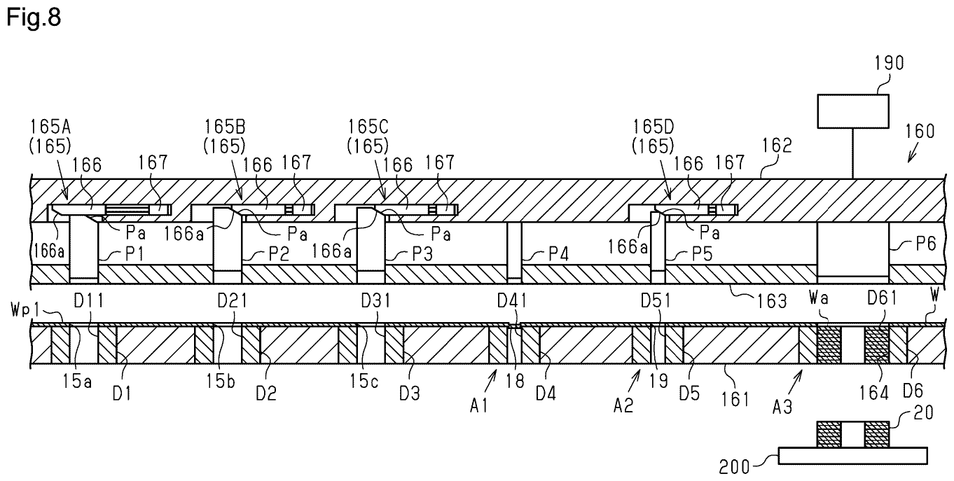

As shown in FIG. 8, the rotor press device 160 includes a progressive die, in which multiple processes such as punching are performed on the workpiece W, which is intermittently conveyed.

The rotor press device 160 includes a lower die assembly 161 and an upper die assembly 162, which is configured to approach and move away from the lower die assembly 161. The lower die assembly 161 includes dies D1 to D6 in that order from the upstream side in the conveying direction. The upper die assembly 162 includes punches P1 to P6 at positions corresponding to the dies D1 to D6, respectively. The dies D1 to D5 and the punches P1 to P5 are each provided in a plurality on concentric circles, but for illustrative purposes, FIG. 8 shows one each of the dies D1 to D5 and the punches P1 to P5 on the same cross section.

The upper die assembly 162 includes a stripper plate 163, which holds the workpiece W against the lower die assembly 161 when the workpiece W is punched. The stripper plate 163 is urged toward the lower die assembly 161 by an urging member (not shown). The punches P1 to P6 extend through the stripper plate 163.

The dies D1 each include a die hole D11, in which the punch P1 moves back and forth. The punches P1 cooperate with the dies D1 to form the through-holes 15a, which form first passages 16, in the workpiece W. The rotor core pieces Wa from which the parts in which the through-holes 15a are formed have been punched out form a first block 21, a second block 22, a fifth block 25, and a sixth block 26.

The dies D2 each include a die hole D21, in which the punch P2 moves back and forth. The punches P2 cooperate with the dies D2 to form the through-holes 15b, which form the first passages 16 and the outer passages 17b, in the workpiece W. The rotor core piece Wa from which the parts in which the through-holes 15b are formed are punched out form parts of the third block 23 and the fourth block 24.

The dies D3 each include a die hole D31, in which the punch P3 moves back and forth. The punches P3 cooperate with the dies D3 to form the through-holes 15c, which form the inner passages 17a, in the workpiece W. The rotor core piece Wa from which the parts in which the through-holes 15c are formed are punched out form parts of the third block 23 and the fourth block 24.

The dies D4 each include a die hole D41, in which the punch P4 moves back and forth. The punches P4 cooperate with the dies D4 to form the tabs 18 in the workpiece W. The dies D4 and the punches P4 form a tab forming unit A1.

The dies D5 each include a die hole D51, in which the punch P5 moves back and forth. The punches P5 cooperate with the dies D5 to selectively punch out some of the tabs 18 from the workpiece W, thereby forming press-fit holes 19 in the workpiece W. The dies D5 and the punches P5 form a press-fit hole forming unit A2.

The die D6 include a die hole D61, in which the punch P6 moves back and forth. The punch P6 cooperates with the die D6 to punch out rotor core pieces Wa from the workpiece W and stack the rotor core pieces Wa in the die D6. The die D6 and the punch P6 form a punching unit A3.

In the die D6, the rotor core pieces Wa are stacked with the tabs 18 coupled to each other. In the die D6, the rotor core pieces Wa including the tabs 18 are stacked on the rotor core piece Wa including the press-fit holes 19, so that the core piece blocks 20 are formed. The core piece blocks 20 are not joined to each other while being in contact with each other inside the die D6.

The lower die assembly 161 includes an ejection port 164, which is connected to the die hole D61. The diameter of the ejection port 164 is preferably greater than or equal to the diameter of the die hole D61.

As the rotor core pieces Wa are sequentially punched out, the core piece block 20 located inside the die D6 is gradually pushed down and eventually falls due to its own weight. As a result, the core piece block 20 is ejected from the ejection port 164. In this manner, the punching unit A3 forms core piece blocks 20 inside the die D6 and ejects the core piece blocks 20 to the outside of the lower die assembly 161 through the ejection port 164.

Although not illustrated, the rotor press device 160 is additionally provided with dies and punches for forming, in the workpiece W, through-holes that form the magnet housing holes 14 and a through-hole that forms the center hole 12.

The upper die assembly 162 incorporates switching mechanisms 165, which individually switch the states of the punches P1, P2, P3, and P5 between a punching state, in which the punches P1, P2, P3 can punch the workpiece W, and a non-punching state, in which the punches P1, P2, P3 cannot punch the workpiece W. The punching state is an example of “the state in which the punches can machine the workpiece.” The non-punching state is an example of “the state in which the punches cannot machine the workpiece.”

In the following description, the switching mechanisms 165 corresponding to the respective punches P1, P2, P3, and P5 may be referred to as a switching mechanism 165A, a switching mechanism 165B, a switching mechanism 165C, and a switching mechanism 165D, respectively.

Each switching mechanism 165 includes, for example, a sliding member 166 and an actuator 167, which reciprocates the sliding member 166 horizontally.

The sliding member 166 includes a facing surface 166a, which faces an inclined surface Pa formed at the base end of each of the punches P1, P2, P3, P5. The actuator 167 is, for example, an air cylinder. Operation of the actuator 167 is controlled by the controller 190. The actuator 167 outputs an ON signal to the controller 190 when the sliding member 166 is advanced. The actuator 167 outputs an OFF signal to the controller 190 when the sliding member 166 is retracted.

The manner in which the switching mechanisms 165 switch the states of the punches P1, P2, P3, and P5 will now be described using a switching mechanism 165A that switches the state of each punch P1 as an example. The manner in which the switching mechanisms 165 switch the punches P2, P3, and P5 is the same as the manner in which the punches P1 are switched, and the description thereof will be omitted.

When each actuator 167 moves the corresponding sliding member 166 forward, the facing surface 166a of the sliding member 166 pushes the inclined surface Pa of the corresponding punch P1 so that the punch P1 receives a downward force. This moves the punches P1 downward with respect to the upper die assembly 162. Thereafter, the lower surface of the sliding member 166 and the base end surfaces of the punches P1 contact each other, so that movement of the punches P1 relative to the upper die assembly 162 is restricted. In this state, the upper die assembly 162 is lowered to punch out the through-holes 15a from the workpiece W. In other words, as the sliding member 166 is advanced, the state of the punches P1 is switched to the punching state.

When each sliding member 166 is retracted by the corresponding actuator 167, the facing surface 166a of the sliding member 166 and the inclined surface Pa of the corresponding punch P1 face each other with a clearance in between. In this state, the upper die assembly 162 is lowered so that the punches P1 are pressed against the workpiece W, and the punches P1 are retracted into the clearance. This causes the facing surface 166a to contact the inclined surface Pa. Thus, even if the upper die assembly 162 is lowered, the through-holes 15a are not punched out by the punches P1. In other words, as the sliding member 166 is retracted, the state of the punches P1 is switched to the non-punching state.

Based on commands from the controller 190, each switching mechanism 165 switches the state of the corresponding punch P1 between the punching state and the non-punching state at specified points in time.

### Conveying Mechanism 200

As shown in FIGS. 8 and 10, the conveying mechanism 200 for conveying the core piece blocks 20 is provided below the ejection port 164. The conveying mechanism 200 faces the lower die assembly 161 in the vertical direction.

The conveying mechanism 200 is, for example, a belt conveyor. The conveying mechanism 200 conveys the core piece blocks 20, for example, in a direction that is different from the conveying direction of the workpiece W.

As shown in FIG. 11A, the conveying mechanism 200 includes a first conveying path 201 and a second conveying path 202. The first conveying path 201 extends linearly from the position below the ejection port 164. The second conveying path 202 branches from the first conveying path 201 and extends obliquely with respect to the first conveying path 201.

### Detecting Unit 210

As shown in FIG. 10, the detecting unit 210, which detects ejection of the core piece blocks 20 through the ejection port 164, is provided at a position diagonally upward of the conveying mechanism 200. The detecting unit 210 detects the core piece blocks 20 that pass through, for example, a part of the conveying mechanism 200 that is below the lower die assembly 161 and faces the lower die assembly 161.

The detecting unit 210 is, for example, a photoelectric sensor. The detecting unit 210 is configured to detect the upper surface of each core piece block 20. Thus, the detecting unit 210 is capable of detecting the core piece blocks 20 of different stacking heights.

The detecting unit 210 detects whether there are any core piece blocks 20 being conveyed by the conveying mechanism 200, thereby detecting ejection of core piece blocks 20 through the ejection port 164. In other words, the detecting unit 210 indirectly detects the ejection of core piece blocks 20 through the ejection port 164. When detecting a core piece block 20, the detecting unit 210 sends a detection signal to the controller 190.

### Sorting Member 220

As shown in FIGS. 11A and 11B, the sorting member 220 is provided in the first conveying path 201 of the conveying mechanism 200. The sorting member 220 directs the core piece blocks 20 and dummy blocks 20d, which will be discussed below, into different conveying paths.

The sorting member 220 is located above the first conveying path 201. The sorting member 220 is, for example, rod-shaped. The sorting member 220 includes a guiding surface 221, which extends in the conveying direction of the second conveying path 202.

As shown in FIG. 12, the height from the first conveying path 201 to the sorting member 220 is set to be less than the lamination thickness of the core piece blocks 20 and greater than the lamination thickness of the dummy blocks 20d.

The sorting member 220 contacts, for example, the core piece blocks 20 but does not contact the dummy blocks 20d. Specifically, the sorting member 220 guides the core piece blocks 20 moving along the first conveying path 201 to the second conveying path 202 and allows passage of the dummy blocks 20d moving along the first conveying path 201. The core piece blocks 20, which move along the first conveying path 201, contact the guiding surface 221 so as to move from the first conveying path 201 to the second conveying path 202 along the guiding surface 221.

### Stator Press Device 170

As shown in FIG. 7, the stator press device 170 includes a progressive die, in which multiple processes such as punching are performed on the workpiece W, which is intermittently conveyed.

The stator press device 170 has a configuration similar to that of the rotor press device 160. That is, the stator press device 170 includes a lower die assembly 171, an upper die assembly 172, and a stripper plate 173. Although not illustrated, the stator press device 170 includes dies, punches, and switching mechanisms.

The stator press device 170 uses the switching mechanisms to switch the states of the punches, thereby punching out a stator core piece Wb that includes the press-fit holes 56 each time a specified number of stator core pieces Wb including the tabs 55 are punched out. This allows the stator press device 170 to sequentially form multiple core piece blocks 60.

The core piece blocks 60, which are formed by the stator press device 170, are conveyed by a conveying mechanism (not shown) as in the case of the rotor press device 160.

### Second Oil Supply Device 180

The second oil supply device 180 is attached to the stator press device 170.

The second oil supply device 180 includes an outlet 180a, which opens in the lower surface of the stripper plate 173. The second oil supply device 180 discharges machining oil through the outlet 180a, thereby supplying the machining oil to the upper surface of the workpiece W. Specifically, the machining oil discharged from the second oil supply device 180 spreads on the lower surface of the stripper plate 173. Therefore, as the upper die assembly 172 and the lower die assembly 171 in the stator press device 170 are clamped, the machining oil collects on the upper surface of the workpiece W.

The second oil supply device 180 is configured to increase or decrease the supply amount of machining oil per unit time in accordance with increase or decrease in the number of times the stator core pieces Wb are punched out in the stator press device 170 per unit time. The second oil supply device 180 is configured to increase or decrease the supply amount of machining oil per unit time in accordance with, for example, the increase or decrease in the SPM in the stator press device 170.

The second oil supply device 180 increases or decreases the supply amount of machining oil based on commands from the controller 190. When controlling the operation of the stator press device 170 at a specified SPM, the controller 190 controls the operation of the second oil supply device 180 to supply machining oil at a predetermined amount corresponding to that SPM.

### Controller 190

The controller 190 stores the thicknesses of the designated portions Wp measured by the thickness measuring device 130. The controller 190 sequentially accumulates the thicknesses of the designated portions Wp to calculate the lamination thickness of each core piece block 20. The controller 190 calculates the lamination thickness of the rotor core 11 by accumulating the lamination thicknesses of the core piece blocks 20.

The controller 190 controls the operation of the rotor press device 160 to form multiple core piece blocks 20 by selectively punching out the rotor core piece Wa including the press-fit holes 19 so as to limit the lamination thickness of each core piece block 20 within a range of a target thickness. Likewise, the controller 190 controls the operation of the stator press device 170 to form multiple core piece blocks 60 by selectively punching out the stator core piece Wb including the press-fit holes 56 so as to limit the lamination thickness of each core piece block 60 within a range of a target thickness.

The controller 190 adjusts the number of the stacked rotor core pieces Wa in each core piece block 20 such that the lamination thickness of the rotor core 11 falls within the range of the target thickness of the rotor core 11. Likewise, the controller 190 adjusts the number of the stacked stator core pieces Wb in each core piece block 60 such that the lamination thickness of the stator core 51 falls within the range of the target thickness of the stator core 51.

The controller 190 determines whether there is an anomaly in the press-fit hole forming unit A2 based on detection results of the detecting unit 210. The controller 190 determines that there is an anomaly in the press-fit hole forming unit A2 when the detecting unit 210 does not detect ejection of any core piece block 20 within a predetermined detection time. An anomaly in the press-fit hole forming unit A2 refers to, for example, a state in which any of the punches P5 is broken. When the press-fit hole forming unit A2 has an anomaly, the press-fit holes 19 are not formed because the tabs 18 are not punched out from the workpiece W although the sliding member 166 of the switching mechanism 165D is advancing.

When the tabs 18 are not punched out due to an anomaly in the press-fit hole forming unit A2, the core piece blocks 20 are joined to each other inside the die D6. In this case, since the core piece blocks 20 are not ejected from the ejection port 164, the conveying mechanism 200 stops conveying the core piece blocks 20. As a result, the detecting unit 210 stops detecting the core piece blocks 20 within the detection time.

When determining that there is an anomaly in the press-fit hole forming unit A2, the controller 190 stops operation of the rotor press device 160 and the stator press device 170.

### Method for Manufacturing Laminated Iron Core

A method for manufacturing the rotor core 11 and a method for manufacturing the stator core 51 will now be described as a method for manufacturing a laminated iron core. The method for manufacturing the rotor core 11 can be used as the method for manufacturing the stator core 51. Thus, the following description will focus on the method for manufacturing the rotor core 11, and the method for manufacturing the stator core 51 will not be described in detail.

The method for manufacturing the rotor core 11 includes, as preprocessing steps prior to machining of a workpiece W with the rotor press device 160, a thickness measuring step, an average thickness calculating step, a lamination thickness calculating step, a machining oil supplying step, and an applying step. The method for manufacturing the rotor core 11 includes, as steps for machining the workpiece W with the rotor press device 160, a machining step, a tab forming step, a press-fit hole forming step, a stacking step, a machining determination step, and a dummy block forming step. The method for manufacturing the rotor core 11 includes, as steps for machining the core piece blocks 20, an ejecting step, a conveying step, a detecting step, an anomaly determination step, and a sorting step. The method for manufacturing the rotor core 11 includes a block body forming step that forms a block body B by stacking the core piece blocks 20.

### Thickness Measuring Step

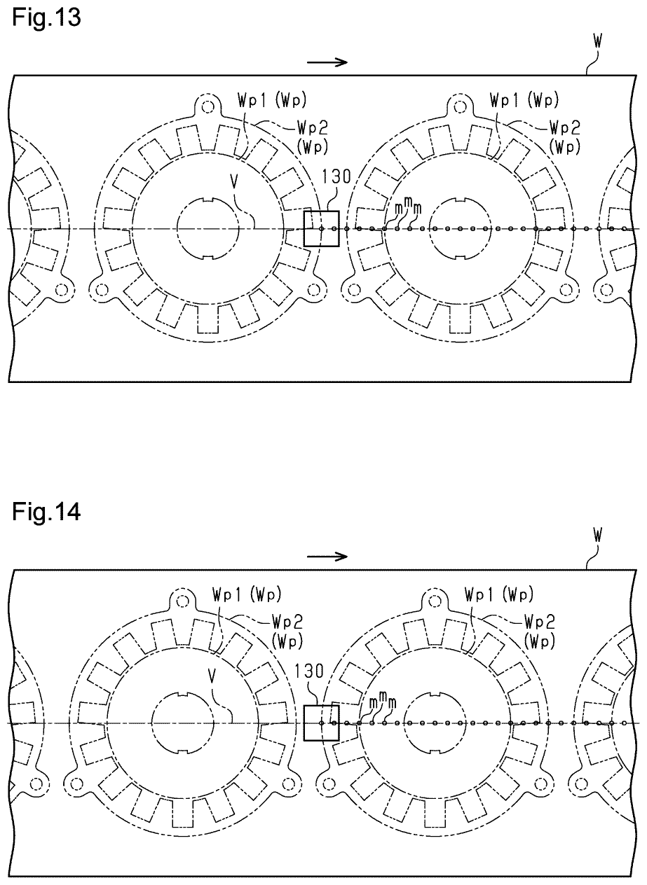

As shown in FIG. 13, in the thickness measuring step, the thickness measuring device 130 measures the thickness of each designated portion Wp at the measurement points m, which are arranged along the imaginary line V indicated by the long-dash short-dash line.

The thickness measuring device 130 constantly measures the thickness of the workpiece W, which is intermittently conveyed by a feed device (not shown), thereby measuring the thickness of the designated portion Wp at the measurement points m arranged in the conveying direction. The thickness measuring device 130 measures, at the measurement points m, the thickness of portions of the workpiece W including each first designated portion Wp1 and the corresponding second designated portion Wp2. The thickness measuring device 130 measures the thickness of the first designated portion Wp1 at the multiple measurement points m and measures the thickness of the second designated portion Wp2 at multiple measurement points m.

Each time movement of the workpiece W, which is intermittently conveyed, is stopped, the thickness measuring device 130 sequentially faces the downstream end in the conveying direction of each second designated portion Wp2 (hereinafter, simply referred to as the downstream end of the second designated portion Wp2).

As shown in FIG. 14, when the workpiece W is moving, the thickness measuring device 130 faces the upstream end in the conveying direction of each second designated portion Wp2 (hereinafter, simply referred to as the upstream end of the second designated portion Wp2). In other words, during movement of the workpiece W, the upstream end of each second designated portion Wp2 passes through a measurement region of the thickness measuring device 130. Thus, the measured values obtained by the thickness measuring device 130 during movement of the workpiece W include the thickness of a portion of the workpiece W from the downstream end to the upstream end of the second designated portion Wp2. Each time the workpiece W moves, the thickness measuring device 130 measures the thickness of a portion of the workpiece W between the downstream end of one second designated portion Wp2 and the downstream end of the subsequent second designated portion Wp2.

### Average Thickness Calculating Step

In the average thickness calculating step, the controller 190 calculates, as the average thickness of each of the rotor core piece Wa and the stator core piece Wb, the average value of the measured values measured by the thickness measuring device 130 in each designated portion Wp.

Each time the workpiece W moves, the controller 190 calculates, as the average thickness, the average of the measured values obtained by the thickness measuring device 130 until obtainment time elapses. The obtainment time is a time from when the workpiece W starts to move to when the upstream end in the conveying direction of each designated portion Wp passes the measurement region of the thickness measuring device 130. Therefore, the obtainment time is shorter than the time during which the workpiece W is moving. The obtainment time is set to a value obtained by dividing, by the moving speed of the workpiece W, the diameter of the second designated portion Wp2, which is the length of the designated portion Wp in the conveying direction. The thickness measuring device 130 is opposed to the downstream end of a designated portion Wp when the workpiece W stops moving and when the workpiece W starts moving. Thus, the measured values obtained by the thickness measuring device 130 during the obtainment time represent the thickness of a portion between the downstream end and the upstream end of the designated portion Wp.

The controller 190 calculates the average value of the measured values of the designated portions Wp as the average thickness of each rotor core piece Wa and the corresponding stator core piece Wb, which are formed by punching out a designated portion Wp. Thus, the average thicknesses of the rotor core piece Wa and the stator core piece Wb that have been punched out from a single designated portion Wp are the same.

### Lamination Thickness Calculating Step

In the lamination thickness calculating step, the controller 190 calculates the lamination thickness of each core piece block 20 by accumulating the average thicknesses of the rotor core pieces Wa in the core piece block 20.

Each time an average thickness is calculated, the controller 190 accumulates the average thicknesses. Thus, the controller 190 calculates the lamination thickness of each core piece block 20 before all the rotor core pieces Wa in the core piece block 20 are punched out.

The controller 190 accumulates the lamination thicknesses of the core piece blocks 20, which form the rotor core 11, thereby calculating the lamination thickness of the rotor core 11, which is the sum of the lamination thicknesses. In the same manner, the controller 190 calculates the lamination thickness of the stator core 51. The controller 190 is also capable of calculating the lamination thickness of the block body B, which will be discussed below.

### Machining Oil Supplying Step

As shown in FIG. 7, in the machining oil supplying step, the first oil supply device 140 and the second oil supply device 180 supply machining oil to the workpiece W, which is intermittently conveyed.

The first oil supply device 140 intermittently drips machining oil from the upper supplying unit 141 to supply the machining oil at multiple locations on the upper surface of the workpiece W. The first oil supply device 140 also forms an oil puddle using the lower supplying unit 142, thereby supplying machining oil to the lower surface of the workpiece W, which passes the oil puddle.

The second oil supply device 180 discharges machining oil through the outlet 180a, thereby supplying the machining oil to the upper surface of the workpiece W when the stator press device 170 is clamped.

The first oil supply device 140 increases or decreases the supply amount of machining oil per unit time in accordance with increase or decrease in the SPM in the rotor press device 160. That is, if the SPM of the rotor press device 160 increases, the supply amount of machining oil of the first oil supply device 140 increases. If the SPM of the rotor press device 160 decreases, the supply amount of machining oil of the first oil supply device 140 decreases. The same applies to the operation of the second oil supply device 180 in relation to the stator press device 170.

In a case in which the SPM of the rotor press device 160 increases or decreases in the stacking step, which will be discussed below, that is, during operation of the rotor press device 160, the first oil supply device 140 increases or decreases the supply amount of machining oil per unit time in accordance with increase or decrease of the SPM. The same applies to the operation of the second oil supply device 180 in relation to the stator press device 170.

The machining and punching of the second designated portion Wp2 are performed on the workpiece W by the stator press device 170 in a state in which the rotor core piece Wa has been punched out. Therefore, when the machining and punching of the second designated portion Wp2 are performed, the supply amount of machining oil to the workpiece W is smaller than when the machining and punching of the first designated portion Wp1 are performed. The supply amount of machining oil per unit time in the second oil supply device 180 is set to be always smaller than the supply amount of machining oil per unit time in the first oil supply device 140.

### Applying Step

In the applying step, the application roller assembly 150 spreads the machining oil supplied to the workpiece W by the first oil supply device 140.

In the applying step, the upper roller 151 and the lower roller 152 slide against the upper surface and the lower surface of the moving workpiece W. As a result, the upper roller 151 spreads machining oil on the upper surface of the workpiece W, and the lower roller 152 spreads machining oil on the lower surface of the workpiece W.

### Machining Step

In the machining step, the rotor press device 160 sequentially performs multiple types of machining on each designated portion Wp.

In the machining step, the through-holes 15a to 15c, which form the cooling passages 15, are selectively formed in the first designated portion Wp1. In the machining step, the first designated portion Wp1 may be subjected to machining different from the formation of the through-holes 15a to 15c. In the machining step, for example, through-holes that form the center hole 12 and the magnet housing holes 14 may be formed in the first designated portion Wp1.

In the machining step, as shown in FIG. 8, the upper die assembly 162 is lowered, so that the stripper plate 163 presses the workpiece W against the lower die assembly 161. Subsequently, the upper die assembly 162 is further lowered, so that the punches P1 enter the die holes D11 of the dies D1. Accordingly, the punches P1 and the dies D1 form the through-holes 15a in the first designated portion Wp1. Like the through-holes 15a, the through-holes 15b, and the through-holes 15c are formed in the first designated portion Wp1.

When forming the through-holes 15a in the first designated portion Wp1, the controller 190 controls the operation of the switching mechanisms 165A to 165C so that the punches P1 are set to the punching state, and the punches P2 and the punches P3 are set to the non-punching state. Accordingly, the first designated portion Wp1, in which the through-holes 15a are to be formed, is machined by the punches P1, but is not machined by the punches P2 or the punches P3.

When forming the through-holes 15b in the first designated portion Wp1, the controller 190 controls the operation of the switching mechanisms 165A to 165C so that the punches P2 are set to the punching state, and the punches P1 and the punches P3 are set to the non-punching state. Accordingly, the first designated portion Wp1, in which the through-holes 15b are to be formed, is machined by the punches P2, but is not machined by the punches P1 or the punches P3.

When forming the through-holes 15c in the first designated portion Wp1, the controller 190 controls the operation of the switching mechanisms 165A to 165C so that the punches P3 are set to the punching state, and the punches P1 and the punches P2 are set to the non-punching state. Accordingly, the first designated portion Wp1, in which the through-holes 15c are to be formed, is machined by the punches P3, but is not machined by the punches P1 or the punches P2.

In the machining step, the stator press device 170 may sequentially perform multiple types of machining on the second designated portion Wp2 in the same manner as the rotor press device 160.

### Tab Forming Step

In the tab forming step, the tab forming unit A1 of the rotor press device 160 forms the tabs 18 in each designated portion Wp.

The tab forming unit A1 forms the tabs 18 in all the first designated portions Wp1. In the tab forming step, the upper die assembly 162 is lowered, so that the stripper plate 163 presses the workpiece W against the lower die assembly 161. Subsequently, the upper die assembly 162 is further lowered, so that the punches P4 push the first designated portion Wp1 into the die holes D41 of the dies D4. This forms the tabs 18 in the first designated portion Wp1 by performing half-blanking on the first designated portion Wp1.

In the same manner as the rotor press device 160, the stator press device 170 forms the tabs 55 on all the second designated portions Wp2.

### Press-Fit Hole Forming Step

In the press-fit hole forming step, the press-fit hole forming unit A2 of the rotor press device 160 selectively punches out the tabs 18 from each designated portion Wp to form the press-fit holes 19.

The press-fit hole forming unit A2 forms the press-fit holes 19 in specific one of the first designated portions Wp1 by punching out the tabs 18 in the first designated portion Wp1.

In the press-fit hole forming step, the upper die assembly 162 is lowered, so that the stripper plate 163 presses the workpiece W against the lower die assembly 161. Subsequently, the upper die assembly 162 is further lowered, so that the punches P5 enter the die holes D51 of the dies D5. This forms the press-fit holes 19 in the first designated portion Wp1 by punching out the tabs 18 formed on the first designated portion Wp1.

In the same manner as the rotor press device 160, the stator press device 170 forms the press-fit holes 56 in specific one of the second designated portions Wp2 by punching out the tabs 55 formed on the second designated portion Wp2.

### Stacking Step

The stacking step includes a rotor punching-out step, a stator punching-out step, and a core piece block forming step. The rotor punching-out step is a step of punching out rotor core pieces Wa from the workpiece W. The stator punching-out step is a step of punching out a stator core piece Wb from the workpiece W on a radially outer side of a portion from which a rotor core piece Wa has been punched out such that the stator core piece Wb is concentric with the portion from which the rotor core piece Wa has been punched out. The core piece block forming step includes a step of forming the core piece block 20 by stacking the rotor core pieces Wa and a step of forming the core piece block 60 by stacking the stator core pieces Wb.

In the stacking step, the punching unit A3 of the rotor press device 160 punches out the rotor core pieces Wa from the workpiece W and stack the punched-out rotor core pieces Wa to form the core piece block 20.

In the rotor punching-out step, the upper die assembly 162 is lowered, so that the stripper plate 163 presses the workpiece W against the lower die assembly 161. Subsequently, the upper die assembly 162 is further lowered, so that the punch P6 enters the die hole D61 of the die D6. Accordingly, the punch P6 and the die D6 punch out a rotor core piece Wa from the workpiece W.

In the core piece block forming step, the rotor press device 160 stacks the rotor core pieces Wa, which have been punched out from the workpiece W, in the die hole D61 in a state in which the tabs 18 are coupled to each other.

Each time punching out a specified number of rotor core pieces Wa in which tabs 18 are formed, the rotor press device 160 punches out a rotor core pieces Wa in which press-fit holes 19 are formed. As a result, the rotor press device 160 forms core piece blocks 20, which are stacked to have a specified stacking height, in the die hole D61. The rotor press device 160, for example, sequentially forms the first to sixth blocks 21 to 26 in that order.

In the same manner as the rotor press device 160, the stator press device 170 punches out stator core pieces Wb from the workpiece W and stacks the stator core pieces Wb to form core piece blocks 60.

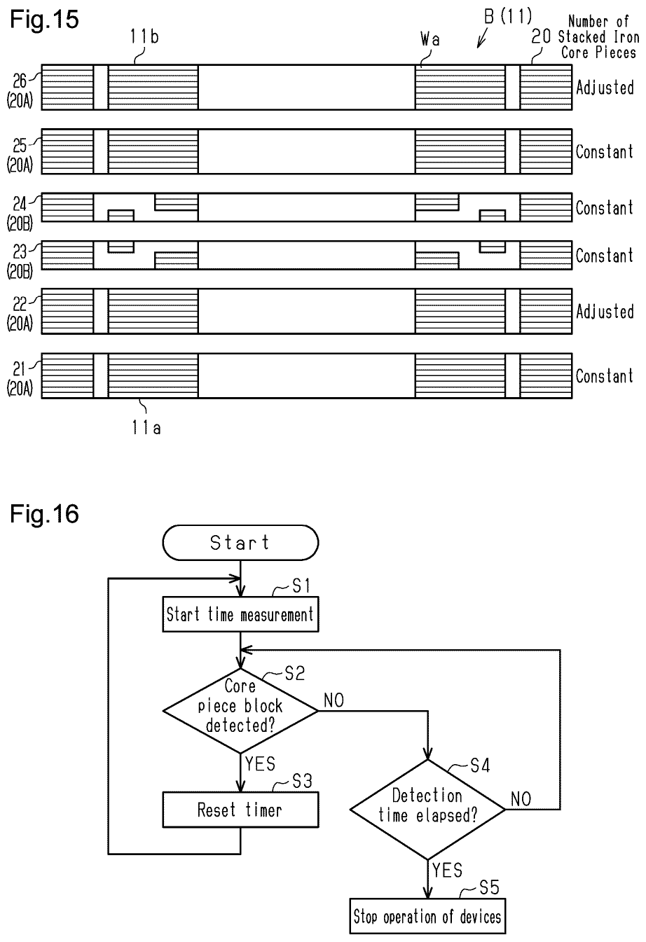

As shown in FIG. 15, in the core piece block forming step, the rotor press device 160 adjusts the numbers of the stacked core pieces in each core piece block 20 based on the difference between the lamination thickness of the rotor core pieces Wa obtained in the lamination thickness calculating step and the target value of the lamination thickness.

When forming the first block 21, which is on the side corresponding to the lower surface 11a of the rotor core 11 in relation to the second block 22, the rotor press device 160 sets the number of the stacked rotor core pieces Wa in the first block 21 to a predetermined constant number.

When forming the second block 22, which is adjacent to the third block 23 in the rotor core 11, the rotor press device 160 adjusts the number of the stacked rotor core pieces Wa in the second block 22. The rotor press device 160 adjusts the number of the stacked core pieces in the second block 22 such that the lamination thickness of the rotor core pieces Wa stacked from the lower surface of the first block 21 to the contact surface of the second block 22 that is in contact with the third block 23 is within a target range of the lamination thickness. The lamination thickness of the rotor core pieces Wa in this case is the sum of the lamination thickness of the first block 21 and the lamination thickness of the second block 22.

When forming the third block 23 and the fourth block 24, the rotor press device 160 sets the number of the stacked rotor core pieces Wa in the third block 23 and the fourth block 24 to a constant number.

When forming the fifth block 25, which is located between the sixth block 26 and the fourth block 24, the rotor press device 160 sets the number of the stacked rotor core pieces Wa in the fifth block 25 to a constant number.

When forming the sixth block 26, which forms the upper surface 11b of the rotor core 11, the rotor press device 160 adjusts the number of the stacked rotor core pieces Wa in the sixth block 26. The rotor press device 160 adjusts the number of the stacked rotor core pieces Wa in the sixth block 26 such that the lamination thickness of the rotor core pieces Wa stacked between the lower surface of the first block 21 and the upper surface of the sixth block 26 falls within a target range of the lamination thickness.

As described above, the rotor press device 160 adjusts the numbers of the stacked core pieces in the second block 22 and the sixth block 26, while maintaining the numbers of the stacked core pieces in the first block 21, the third block 23, the fourth block 24, and the fifth block 25 to be constant.

In the stacking step, the stator press device 170 forms the core piece blocks 60 of the stator core 51 in the same manner as the rotor press device 160. The number of the stacked core pieces in the core piece blocks 60 of the stator core 51 may be adjusted in any of the core piece blocks 60.

### Machining Determination Step

In the machining determination step, the controller 190 determines whether standard machining has been performed on each designated portion Wp. The machining determination step includes determining whether machining has been performed on sections of the designated portion Wp where machining needs to be performed and determining whether machining has been performed on sections of the designated portion Wp where machining should not be performed.

As shown in FIG. 8, the controller 190 determines whether the standard machining has been performed on the first designated portion Wp1 based on the operation points in time of the switching mechanisms 165. The controller 190 determines whether each switching mechanism 165 is operating at specified points in time based on whether an ON signal and an OFF signal output by the actuator 167 of the switching mechanism 165 are output at the specified points in time.

Next, as an example of the machining determination step, a case will be described in which the controller 190 determines whether the through-holes 15a have been formed in sections of the first designated portion Wp1 where the through-hole 15a should be formed.

If an ON signal is output from the actuators 167 of each switching mechanisms 165A at a point in time when the through-holes 15a should be formed in the first designated portion Wp1, the controller 190 determines that the through-holes 15a are correctly formed in the first designated portion Wp1. In contrast, if an OFF signal is output from the actuator 167 of each switching mechanism 165A at the point in time when the through-holes 15a should be formed in the first designated portion Wp1, the controller 190 determines that the through-holes 15a are not correctly formed in the first designated portion Wp1.

Next, a case will be described in which the controller 190 determines whether the through-holes 15a have been formed in sections of the first designated portion Wp1 where the through-holes 15a should not be formed.

If an ON signal is output from the actuator 167 of each switching mechanism 165a at the point in time when the through-holes 15a should not be formed in the first designated portion Wp1, the controller 190 determines that the through-holes 15a are erroneously formed in the first designated portion Wp1. In contrast, if an OFF signal is output from the actuator 167 of each switching mechanism 165a at the point in time when the through-holes 15a should not be formed in the first designated portion Wp1, the controller 190 determines that the through-holes 15a are not formed in the first designated portion Wp1.

In the machining determination step, in the same manner as the rotor press device 160, the stator press device 170 determines whether the second designated portion Wp2 has been subjected to the standard machining.

### Dummy Block Forming Step

In the dummy block forming step, the rotor press device 160 forms a dummy block 20d (refer to FIG. 12) when it is determined in the machining determination step that standard machining has not been performed on the designated portion Wp.

The rotor press device 160 forms a dummy block 20d if it is determined that machining has not been performed on sections of the first designated portion Wp1 where machining should be performed. Also, the rotor press device 160 forms a dummy block 20d if it is determined that a machining has been performed on sections of the first designated portion Wp1 where machining should not be performed.

The dummy block 20d is formed by stacking multiple rotor core pieces Wa including the rotor core piece Wa formed by punching out a first designated portion Wp1 on which the standard machining has not been performed, such that the stacking height of the dummy block 20d is different from a specified stacking height of the core piece block 20.

The rotor press device 160 adjusts the stacking height of the dummy block 20d by differentiating the point in time at which the press-fit holes 19 are formed in the first designated portion Wp1 from the point in time at which the standard core piece block 20 is formed. The rotor press device 160 forms the dummy block 20d such that, for example, the stacking height of the dummy block 20d is less than the specified stacking height of the core piece blocks 20. The stacking height of the dummy block 20d is less than, for example, the stacking height of the third block 23 and the fourth block 24.

In the dummy block forming step, when it is determined in the machining determination step that the standard machining has not been performed on the second designated portion Wp2, the stator press device 170 forms a dummy block in the same manner as the rotor press device 160. In this case, the dummy block is formed by stacking multiple stator core pieces Wb including the stator core piece Wb formed by punching out a second designated portion Wp2 on which the standard machining has not been performed, such that the stacking height of the dummy block is different from a specified stacking height of the core piece block 60.

### Ejecting Step

In the ejecting step, the punching unit A3 ejects the core piece blocks 20 and the dummy blocks 20d to the outside of the lower die assembly 161 through the ejection port 164

The core piece blocks 20 are stacked without being joined together inside the die D6. Thus, when each core piece block 20 is lowered to a specified position as the rotor core pieces Wa are successively punched out from the workpiece W, the core piece block 20 is ejected to the outside of the lower die assembly 161 due to its own weight through the ejection port 164. The core piece block 20 ejected through the ejection port 164 drops onto the upper surface of the conveying mechanism 200. The dummy block 20d is ejected in the same manner as the core piece block 20.

In the ejecting step, the stator press device 170 ejects the core piece block 60 to the outside in the same manner as the rotor press device 160.

### Conveying Step

In the conveying step, the conveying mechanism 200 conveys the core piece blocks 20 and the dummy blocks 20d. In the conveying step, the core piece blocks 20 and the dummy blocks 20d, which are ejected from the ejection port 164, are conveyed on the conveying mechanism 200 while being spaced apart from each other.

In the conveying step, the core piece blocks 60 are conveyed in the same manner as the core piece blocks 20.

### Detecting Step

As shown in FIG. 10, in the detecting step, the detecting unit 210 detects ejection of the core piece blocks 20 through the ejection port 164.

The detecting unit 210 detects whether there are any core piece blocks 20 being conveyed by the conveying mechanism 200, thereby detecting ejection of core piece blocks 20 through the ejection port 164. Thus, in the detecting step, ejection of each core piece block 20 through the ejection port 164 is indirectly detected.

In the present embodiment, the stacking height of the first passage block 20A is greater than the stacking height of the second passage block 20B. Thus, the detection interval at which the detecting unit 210 detects the core piece blocks 20 is longer in a case in which the first passage blocks 20A are continuously conveyed than in a case in which the second passage blocks 20B are continuously conveyed. Thus, the maximum value of the detection interval of the detecting unit 210 is the detection interval for continuous detection of the first passage blocks 20A.

In the detecting step, ejection of each core piece block 60 from the stator press device 170 is detected in the same manner as the core piece blocks 20.

### Anomaly Determination Step

In the anomaly determination step, the controller 190 determines whether the press-fit hole forming unit A2 has an anomaly based on the detection result in the detecting step.

The controller 190 determines that there is an anomaly in the press-fit hole forming unit A2 when the detecting unit 210 does not detect ejection of any core piece block 20 within a predetermined detection time.

The detection time is set to, for example, a time longer than the maximum value of the detection interval of the detecting unit 210. The detection time is set to be, for example, longer than or equal to a time required by three or more core piece blocks 20 to pass through the detection region of the detecting unit 210 on the conveying mechanism 200.

When there is an anomaly in the press-fit hole forming unit A2, the press-fit holes 19 are not formed in the workpiece W. Thus, the core piece blocks 20 are not ejected from the ejection port 164. Accordingly, the detecting unit 210 does not detect the core piece blocks 20.

The anomaly determining process executed by the controller 190 during the anomaly determination step will now be described with reference to the flowchart shown in FIG. 16.

First, the controller 190 starts a timer to start time measurement (step S1).

Next, the controller 190 determines whether the detecting unit 210 has detected a core piece block 20 (step S2). When the detecting unit 210 detects a core piece block 20 (step S2: YES), the controller 190 resets the timer (step S3). Subsequently, the controller 190 executes the process of step S1 again. When the detecting unit 210 does not detect a core piece block 20 (step S2: NO), the controller 190 determines whether a detection time has elapsed (step S4).

When determining in step S4 that the detection time has elapsed (step S4: YES), the controller 190 stops the operation of the rotor press device 160 and the stator press device 170 (step S5). When determining in step S4 that the detection time has not elapsed (step S4: NO), the controller 190 executes the process of step S2.

In the anomaly determination step, when ejection of a core piece block 60 is not detected within the predetermined detection time, the controller 190 determines that there is an anomaly in the portion of the stator press device 170 that forms the press-fit holes 56, in the same manner as the rotor press device 160.

### Sorting Step

As shown in FIGS. 11A and 11B, in the sorting step, the sorting member 220 sorts the core piece blocks 20 and the dummy blocks 20d, which are conveyed by the conveying mechanism 200, into different conveying paths.

As shown in FIG. 11A, the core piece blocks 20 are guided to the second conveying path 202 by contacting the sorting member 220. Accordingly, the core piece blocks 20 are conveyed in a direction different from the conveying direction before contacting the sorting member 220.

As described above, the stacking height of the dummy blocks 20d is less than the stacking height of the core piece blocks 20. Thus, as shown in FIG. 11B, the dummy blocks 20d pass below the sorting member 220 without contacting the sorting member 220. Therefore, the dummy blocks 20d are conveyed on the first conveying path 201 without the conveying direction being changed.

In the sorting step, in the same manner as the core piece blocks 20 and the dummy blocks 20d, the dummy blocks and the core piece blocks 60, which have been formed by the stator press device 170, are sorted into different conveying paths.

### Block Body Forming Step

As shown in FIG. 15, in the block body forming step, a device or an operator (neither is shown) forms a block body B by stacking multiple core piece blocks 20. The block body B includes first passage blocks 20A and second passage blocks 20B.

In the block body forming step, two second passage blocks 20B are stacked, from the side opposite to the lower surface 11a, on two adjacently stacked first passage blocks 20A that include the first passage block 20A forming the lower surface 11a of the rotor core 11. Subsequently, two adjacently stacked first passage blocks 20A that include the first passage block 20A forming the upper surface 11b of the rotor core 11 are stacked on the two second passage blocks 20B. In the present embodiment, the first to sixth blocks 21 to 26 are stacked in that order to form the block body B.

In the block body forming step, the core piece blocks 20 may be stacked inside the rotor press device 160, or the core piece blocks 20 may be stacked on a jig inserted into the core piece block 20. In the block body forming step, the core piece blocks 20 may be stacked by the rotational stacking method, in which the respective core piece blocks 20 are rotated by a specified angle about the center hole 12 while being stacked.

The block body B, which is formed in the block body forming step, is subjected to specified treatments such as a pressurizing treatment and a thermal treatment to form the rotor core 11.

In the block body forming step, the core piece blocks 60 are stacked in the same manner as the core piece blocks 20 to form a block body.

Operation and advantages of the present embodiment will now be described.
(1) In the machining step, the multiple types of machining are sequentially performed on each designated portion Wp. In the machining determination step, it is determined whether standard machining has been performed on each designated portion Wp. In the block forming step, each core piece block 20 is formed by stacking the rotor core pieces Wa to have the specified stacking height. In the dummy block forming step, a dummy block 20d is formed when it is determined in the machining determination step that standard machining has not been performed on the designated portion Wp.

With this method, the rotor core pieces Wa in the dummy block 20d include a rotor core piece Wa that has a shape different from the desired shape. Since the stacking height of the dummy block 20d is different from the stacking height of the core piece block 20, the dummy block 20d and the core piece block 20 are easily distinguished from each other. This prevents the dummy blocks 20d from being incorporated in the rotor cores 11. Accordingly, the rotor core 11 is prevented from including rotor core pieces Wa having shapes different from the desired shape.
(2) In the machining step, the switching mechanisms 165 are used to switch the state of the punches P1 to P3 between the punching state, in which the punches P1 to P3 can punch the workpiece W, and the non-punching state, in which the punches P1 to P3 cannot punch the workpiece W, so that each designated portion Wp1 is selectively machined. In the machining determination step, it is determined whether the standard machining has been performed on the first designated portion Wp1 based on the operation points in time of the switching mechanisms 165.

With this method it is determined whether the standard machining has been performed on the first designated portion Wp1 based on the operation points in time of the switching mechanisms 165. This eliminates the need to directly check whether the standard machining has been performed on the first designated portion Wp1. This facilitates the execution of the machining determination step.
(3) In the sorting step, the sorting member 220 is used to sort the core piece blocks 20 and the dummy blocks 20d into different conveying paths.

With this method, when the stacking height of the dummy block 20d is higher than the stacking height of the core piece block 20, the dummy block 20d contacts the sorting member 220, so that the core piece block 20 and the dummy block 20d are sorted into different conveying paths. Also, when the stacking height of the dummy block 20d is lower than the stacking height of the core piece block 20, the core piece block 20 contacts the sorting member 220, so that the core piece block 20 and the dummy block 20d are sorted into different paths. Accordingly, the dummy blocks 20d and the core piece blocks 20 are sorted by the simple method.
(4) In the dummy block forming step, the dummy block 20d is formed such that the stacking height of the dummy block 20d is less than the stacking height of the core piece block 20.

This method prevents the number of the stacked rotor core pieces Wa used in the dummy block 20d from being increased. Accordingly, the number of the rotor core pieces Wa that do not form the rotor core 11 is reduced.

The operation and advantages described above can be interpreted as the operation and advantages related to the stator core 51 and the stator press device 170.

### MODIFICATIONS

The above-described embodiment may be modified as follows. The above-described embodiment and the following modifications can be combined as long as the combined modifications remain technically consistent with each other.

In the dummy block forming step, the dummy block 20d may be formed such that the stacking height of the dummy block 20d is greater than the stacking height of the core piece block 20. In this case, a sensor that detects the dummy block 20d but does not detect the core piece block 20 may be provided on the conveying path of the conveying mechanism 200. As such a sensor, a photoelectric sensor may be used that is provided on the conveying path of the conveying mechanism 200 at a position that is higher than the stacking height of the core piece block 20 and lower than the stacking height of the dummy blocks 20d. With this configuration, the sensor reacts only when the dummy block 20d passes on the conveying path of the conveying mechanism 200. In a case in which such a sensor is not used, the height from the conveying path of the conveying mechanism 200 to the sorting member 220 may be set to be higher than the lamination thickness of the core piece block 20 and lower than the lamination thickness of the dummy block 20d.

The sorting step may be omitted. In this case, for example, a robotic arm may remove the dummy block 20d from the conveying mechanism 200 based on the difference in stacking height between the core piece block 20 and the dummy block 20d. Further, an operator may visually identify the dummy block 20d and remove the dummy block 20d from the conveying mechanism 200.

In the machining determination step, the controller 190 may determine whether the designated portion Wp has been subjected to the standard machining by comparing an image of the designated portion Wp captured by an image capturing device with an image of the designated portion Wp that has been prepared in advance.

In the machining step, in addition to or in place of the machining for forming the through-holes 15a to 15c in the designated portion Wp, machining for forming various types of through-holes may be performed. Also, half-blanking may be performed.

The laminated body of the rotor core 11 may be formed by a single core piece block. In this case, the rotor core piece Wa including the press-fit holes 19 is provided at only one end in the stacking direction of the rotor core 11.

The manufacturing apparatus 100 may punch out either the rotor core pieces Wa or the stator core pieces Wb from the workpiece W.

When the part of the workpiece W welded by the welding device 120 is included in each designated portion Wp, a dummy block may be formed that includes the rotor core piece Wa formed by punching out this designated portion Wp. The stacking height of the dummy block is preferably different from the specified stacking height of the core piece blocks 20. In this case, the core piece blocks 20 and the dummy blocks are sorted into different conveying paths in the sorting step.

The above-described modifications related to the rotor press device 160 and the method for manufacturing the rotor core 11 can also be applied to the stator press device 170 and the method for manufacturing the stator core 51.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a laminated iron core that includes multiple stacked core piece blocks, each core piece block including stacked iron core pieces that are punched out from a plate-shaped workpiece that is intermittently conveyed, the method comprising:
sequentially performing multiple types of machining on designated portions of the workpiece from which the iron core pieces are to be punched out;
determining whether standard machining has been performed on each designated portion;
forming each core piece block by stacking the iron core pieces to have a specified stacking height; and
forming, when it is determined that the standard machining has not been performed on any of the designated portions through the determining whether standard machining has been performed, a dummy block by stacking the iron core pieces that include the iron core piece formed by punching out the designated portion not having been subjected to the standard machining, the formed dummy block having a stacking height different from the specified stacking height.

2. The method for manufacturing the laminated iron core according to claim 1, wherein
the sequentially performing the multiple types of machining on the designated portions includes selectively machining the designated portions by switching, using a switching mechanism, a state of multiple types of punches that perform the multiple types of machining on the designated portions between a state in which the punches can machine the workpiece and a state in which the punches cannot machine the workpiece, and
the determining whether the standard machining has been performed includes determining whether the standard machining has been performed on the designated portions based on an operation point in time of the switching mechanism.

3. The method for manufacturing the laminated iron core according to claim 1, further comprising:
conveying the core piece blocks and the dummy block using a conveying mechanism; and
sorting the core piece blocks and the dummy block, which are conveyed by the conveying mechanism, into different conveying paths by using a sorting member that contacts one of each core piece block and the dummy block and does not contact the other one of each core piece block and the dummy block.

4. The method for manufacturing the laminated iron core according to claim 1, wherein the forming the dummy block includes forming the dummy block such that the stacking height of the dummy block is less than the specified stacking height.
